(19) United States
(12) Patent Application Publication
(10) Pub. No.: US 2026/0220763 A1
(43) Pub. Date: Jul. 30, 2026

(54) METHOD FOR IDENTIFYING AND CHARACTERIZING, BY MEANS OF ARTIFICIAL INTELLIGENCE, DEFECTS WITHIN AN OBJECT, INCLUDING CRACKS WITHIN A BRAKE DISC OR CALIPER

(71) Applicant: Brembo S.p.A., Curno, Bergamo (IT)

(72) Inventors: Danilo BENETTI, Curno, Bergamo (IT); Mahshad KHORNEGAH, Curno, Bergamo (IT); Micael RESCATI, Curno, Bergamo (IT)

(21) Appl. No.: 19/142,375

(22) PCT Filed: Dec. 20, 2023
(86) PCT No.: PCT/IB2023/063013

§ 371 Date: Jun. 23, 2025

(30) Foreign Application Priority Data
Dec. 23, 2022 (IT) 102022000026655

(51) Int. Cl. G06T 7/00; G01N 23/04; G01N 23/083; G01N 23/18

(52) U.S. Cl. CPC G06T 7/001; G01N 23/04; G01N 23/083; G01N 23/18; G01N 2223/401; G06T 2207/10116; G06T 2207/20081; G06T 2207/20084; G06T 2207/30108

(57) ABSTRACT

The invention relates to a method (100) for identifying and characterizing defects within an object (OB). The method comprises the steps of:—acquiring (101) at least one digital X-ray image of the object or a part of the object within which the defects are to be identified;—providing (102) the at least one acquired digital image to a trained artificial intelligence, AI, and/or machine learning, ML, algorithm;—analyzing (103), by such a trained algorithm, the at least one acquired digital image to identify one or more defects present in the at least one acquired digital image;—generating (104) digital information on each identified defect, comprising a step of determining (104′) one or more parameters representative of such a defect to characterize the defect;—comparing (105) each of such one or more parameters representative of the identified defect with respective one or more reference values;—providing (106) a piece of information (IQ1, IQ2, IQ3) representative of the quality of the object based on such a comparison. The aforesaid comparing step is performed through a further processing of said digital information, by electronic processing means.

### FIELD OF THE INVENTION

The present invention relates to a method for identifying and characterizing, by means of artificial intelligence (AI), defects within an object.

More particularly, the present invention relates to a method for identifying and characterizing cracks or fissures within the body of a brake disc or a brake caliper or a general foundry blank at the exit of a processing line, based on the analysis of radiographic images of such a brake disc or caliper using artificial intelligence (AI).

### BACKGROUND ART

In order to detect defects associated with an object, using artificial intelligence (AI) and computer vision (CV) techniques is known, applied to the analysis of digital images of the object itself. In particular, such techniques include the analysis, by an appropriately designed algorithm (usually one or more neural networks), of the digital images of the object taken by an operator or by a robot in which defects of different categories, size and severity can be present.

The digital images to be analyzed can be photographic acquisitions of an object, in which case the defects depicted are of the surface type. A known method for detecting, using artificial intelligence, defects present on the surface of an object, such as, for example, cracks on the surface of a brake disc, are described in Italian patent application n. 102021000025085 to the same Applicant.

If the digital images acquired are X-ray images of the object, the defects depicted in such images are inside the body of the object.

In the prior art, detecting defects within the body of an object based on a review of the radiographic images of the object itself by a human operator is known. Such a detection procedure, however, is rather expensive in terms of resources i involved.

Methods are also known for identifying defects within foundry blanks by means of the analysis of X-rays using deep learning (DL) algorithms. However, such known methods do not allow controlling the foundry blanks directly along the processing line and do not ensure a control over the quality of all the blanks produced.

Moreover, in order to obtain a DL algorithm execution time which is less than the cycle time associated with the processing line, it would be necessary to use processing units which are atypical for such lines and make real-time interaction with the machines on the production line impracticable.

A further drawback linked to the use of known DL algorithms is given by the limited number of images used to train such algorithms to recognize defects. This can result in the detection of a large number of false negatives and false positives, limiting the performance of the algorithm.

The need therefore emerges to have a method which, using AI algorithms, allows detecting defects within an object with high accuracy and reliability, such as, for example, cracks or fissures within the body of a brake disc or caliper.

As noted above, such requirements are not fully met by the solutions currently available from the prior art.

### SOLUTION

It is an object of the present invention to devise and provide a method for identifying and characterizing, using artificial intelligence (AI), defects within an object, such as, for example, a brake caliper, a brake disc or a general foundry blank, which allows at least partially overcoming the limitations and drawbacks of the solutions available in the prior art.

Such an object is achieved by a method for identifying and characterizing defects within an object, in accordance with claim 1.

In particular, it is an object of the invention to use AI algorithms, combined with known computer vision (CV) techniques, so as to automatically monitor the quality of the foundry blanks along a processing line. More in detail, it involves automating the identification, cataloging and quantification of the defects present in the blanks downstream of the melting process, so as to perform the following operations for each object present on a processing line:
acquiring radiographic images of the object;
analyzing such images to search for defects within the object;
formulating a judgment regarding the quality of the object based on predefined rules.

The Applicant has verified that the method for identifying and characterizing defects within an object of the invention ensures an execution time which is less than or equal to the cycle time of the processing line, for example of a brake disc production line. Therefore, with such a method it is possible to perform a complete check of all the objects produced, brake discs and calipers or a general foundry blank, directly on the line, automatically selecting the objects that comply with pre-established quality criteria and eliminating those identified like rejects.

Finally, the method disclosed herein allows maximizing the amount of information extracted from the quality checks on the analyzed objects, making it available for the consequent improvement actions during the design or optimization of the production process.

Some advantageous embodiments are the subject of the dependent claims.

### DRAWINGS

Further features and advantages of the method for identifying and characterizing defects within an object of the invention will become apparent from the description given below of preferred embodiments thereof, given by way of non-limiting indication, with reference to the accompanying drawings, in which:

FIG. 1 shows a flow diagram of the operative steps of the method for identifying and characterizing defects within an object according to the present invention which uses a trained artificial intelligence, AI, and/or machine learning ML algorithm;

FIG. 2 diagrammatically shows a station for acquiring digital X-ray images of a foundry blank operatively associated with a working surface of such a blank in a processing line;

FIG. 3 shows a flow diagram of the operative steps of a preliminary training step of the trained algorithm used in the method in FIG. 1;

FIG. 4 shows a radiographic image of a portion of a brake disc which includes defects labelled (tagging step) using the LabelMe software application;

FIG. 5A shows an example image which is provided as input to a machine learning algorithm, during a training step, according to an embodiment of the method of the invention;

FIG. 5B shows an example of an image which is obtained in output from the machine learning algorithm, according to an embodiment of the method of the invention;

FIG. 6 shows a block diagram of a system capable of performing the method according to the invention.

Similar or equivalent elements in the aforesaid figures are indicated by the same reference numerals.

### DESCRIPTION OF SOME PREFERRED EMBODIMENTS

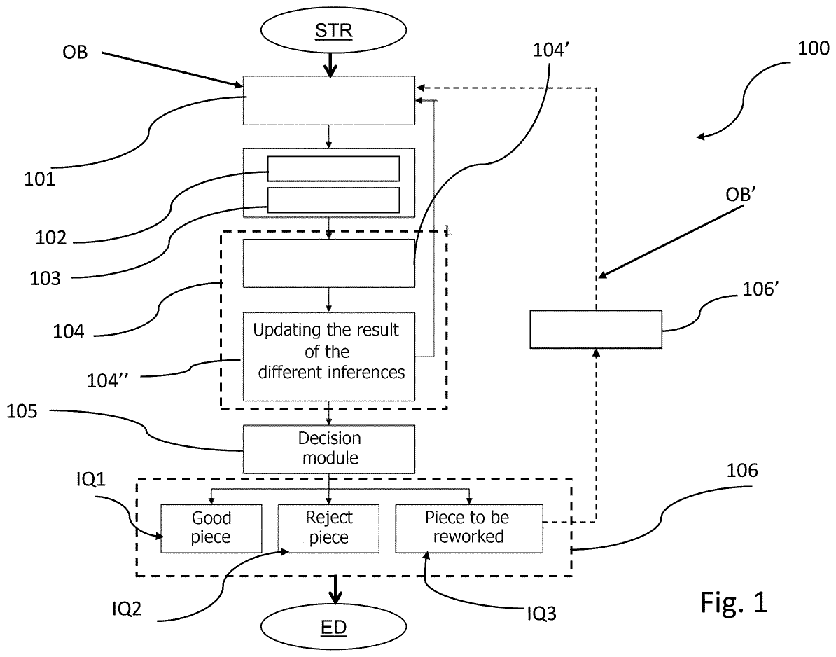

With reference to FIG. 1, reference numeral 100 indicates, as a whole, an example of a method for identifying and characterizing defects within an object OB, according to the present invention, which uses a trained artificial intelligence, AI, and/or machine learning ML algorithm.

The method for identifying and characterizing defects within an object in FIG. 1 begins with a symbolic step of starting “STR” and ends with a symbolic step of ending “ED”.

Such a method 100 for identifying and characterizing defects within an object OB, or more simply method, comprises a step of acquiring 101 at least one digital image, in particular an X-ray image, of the object OB or a part of the object in which the defects are to be identified.

For example, such an object OB is a brake disc or a brake caliper or a general foundry blank.

The method 100 comprises the step of providing 102 such at least one acquired digital image to a trained artificial intelligence, AI, and/or machine learning, ML, algorithm.

A step of analyzing 103, by such a trained algorithm, the aforesaid at least one acquired digital image to identify one or more defects present in the at least one acquired digital image, is then included.

The method 100 includes generating 104 digital information on each identified defect, comprising a step of determining 104′ one or more parameters representative of such a defect to characterize the defect itself.

Moreover, comparing 105 each of the one or more parameters representative of the identified defect with respective one or more reference or threshold values and providing 106 a piece of information IQ1, IQ2, IQ3 representative of the quality of the object OB based on such a comparison is included.

In particular, the aforesaid comparing step 105 (Decision module) is performed through a further processing of the digital information, by electronic processing means.

In accordance with an embodiment of the method 100, the step of determining one or more parameters representative of the identified defect comprises a step of determining:
a type of defect;
at least one dimensional parameter of the defect, representative of at least one dimension of the defect within the object OB;
at least one positional parameter of the defect, representative of a position of the defect within the object OB with respect to a reference point or line present in the digital X-ray image or to a two-dimensional spatial coordinate system associated with said reference point or line.

In accordance with a preferred embodiment of the method 100, the step of providing 106 a piece of information IQ1, IQ2, IQ3 representative of the quality of the object OB comprises a step of providing, alternatively:
a first quality information IQ1 (good piece) characterizing the object OB as suitable when at least one of said one or more parameters representative of the identified defect takes a value less than or equal to the respective reference value; or
a second quality information IQ2 (reject piece) characterizing the object OB as a reject when each of said one or more parameters representative of the identified defect takes a value greater than the respective reference value; or
a third quality information IQ3 (piece to be reworked) characterizing the object OB as an object to be reworked when each of such one or more parameters representative of the identified defect takes a value greater than the respective reference value, and at least one of such one or more parameters representative of the defect can be modified by reworking to take a value less than or equal to the respective reference value.

For example, a blank OB containing a defect of acceptable size can be deemed good or a reject based on the location of the defect in the reference system of the blank itself. Moreover, the presence of a certain type of defect in a blank OB can lead to the identification thereof as a reject regardless of the position and size of the defect itself.

Note that, in several possible embodiments, the method 100 of the invention is used to detect defects of various types within foundry blanks OB, including cracks or breaks, porosity, high and low density inclusions, shrinkage cavities. In the case of blanks having design cavities, such as, for example, brake discs in the ventilation area, it is possible to identify the residual presence of foundry sand.

Moreover, the method 100 shown above, for the features thereof, can be applied to a wide plurality of defects, which can generally be defined as any inhomogeneity which can be captured by an image with respect to a background, for example all the inhomogeneities which the human eye can manage to perceive with respect to a uniform background.

In the embodiment in which the parameter representative of the defect of the object OB modifiable by reworking is the type of the defect, in relation to the specific case of blanks in which it is possible to identify the residual presence of foundry sand, after the step of providing the third quality information IQ3, the method 100 comprises a step of reworking 106′ the object OB to generate a reworked object OB'.

Moreover, there is included a step of acquiring 101 at least one digital X-ray image of the reworked object OB′ to be provided to a trained artificial intelligence, AI, and/or machine learning, ML, algorithm to repeat the aforesaid method 100 so as to identify and characterize defects within said reworked object OB′.

In other words, in some cases, the blank OB is not compliant, but it can be reworked, i.e., it has irregularities, such as, for example, foundry sand not completely detached from the blank during the first processing. In this specific case, the reworking step 106′ is performed by passing the blank through a suitable drum machine which shakes the blank OB to eliminate such a sand. After such a reworking step 106′, the quality and/or conformity of the blank can be evaluated again with the method 100.

According to various implementations, the step of acquiring a digital image, in particular of the radiographic type, is performed using X-ray image acquisition means which are per se known.

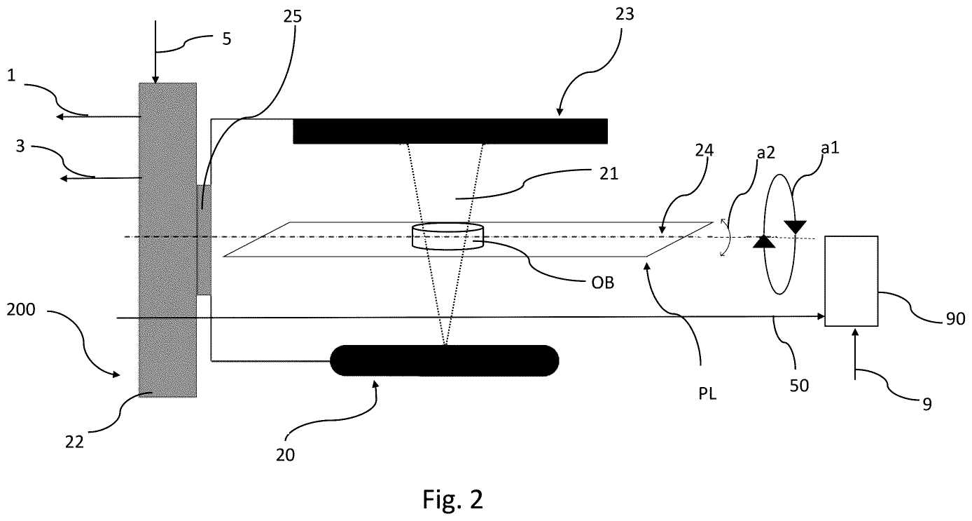

An example of a station 200 for acquiring digital x-ray images of a foundry blank OB operatively associated with a plan PL for processing such a blank in a processing line is described with reference to FIG. 2. The aforesaid station 200 installed along the line, indicated by the arrow 50, comprises an X-ray camera, including a source 20 of X-rays 21 connected to a screen 23 for detecting digital radiographic images.

The aforesaid source 20 and screen 23 face each other and are bound to each other to always take the same mutual position. The source 20 and the screen are connected to a digital image acquisition unit 22 by means of a pin 25 and can be moved integrally to acquire the images of the blanks OB placed on the working surface PL from different angles. In other words, for each blank OB examined, the station 200 acquires a plurality of images, acquired from different angles, such that the images cover the entire volume of the blank.

The management of the image acquisition station 200 is carried out by a software for controlling such a station 200, which acquires the images of the blank OB, autonomously adjusting angle, lighting, contrast, shutter speed and saving the images produced.

In particular, the method 100 of the invention is configured to identify and characterize defects within the body of a blank OB placed on the working surface PL along the processing line 50 using such a digital X-ray image acquisition station 200.

In particular, the image acquisition step 101 comprises a step of acquiring, in sequence, a plurality of digital X-ray images of the blank OB, for example N images for each blank OB.

Each of such digital images is acquired by modifying a first rotation angle al of the source 20 of X-ray beams 21 of the image acquisition station 200 incident on the blank OB around a rotation axis 24 parallel to the working surface PL or by modifying a second rotation angle a2 of the source 20 of x-ray beams 21 of the station 200 incident on the blank OB with respect to the working surface PL. Note that during the aforesaid rotation, the source 20 of X-ray beams 21 always faces the blank OB.

The method includes continuously performing, in sequence, the steps of providing and analyzing each digital image of the plurality of acquired images N.

Moreover, for each digital image of such a plurality N of acquired images, the step of generating 104 digital information on each identified defect is continuously performed in sequence.

Such a step comprises the steps of:
determining 104′ one or more parameters representative of such a defect to characterize the defect,
updating 104″ (updating the result of the different inferences) such one or more parameters representative of the defect so as to monitor the three-dimensional characterization of the defect regarding the type of the defect, the dimension of the defect, and the position of the defect in the image.

According to a first example, such a screen 23 is movable, by the digital image acquisition unit 22, integrally with the source 20 so as to rotate about the rotation axis 24 parallel to the aforesaid working surface PL so that the first rotation angle al of the source 20 of X-ray beams 21 with respect to such an axis 24 takes values from 0° to 360°.

Therefore, the step of sequentially acquiring 101 a plurality N of digital X-ray images of the blank OB comprises a step of acquiring each image of the plurality at a respective plurality of values of the first rotation angle al of the source 20 with respect to the axis 24.

According to a second example, the aforesaid screen 23 is movable, by the digital image acquisition unit 22, integrally with the source 20 so as to rotate about the working surface PL so that the second rotation angle a2 of the source 20 of X-ray beams 21 with respect to such a surface takes values from 0° to 360°.

Therefore, the step of sequentially acquiring 101 a plurality N of digital X-ray images of the blank OB comprises a step of acquiring each image of the plurality at a respective plurality of values of the second rotation angle of the source 20 with respect to the working surface PL.

Again, with reference to FIG. 2, downstream of the digital X-ray image acquisition station 200, the processing line 50 of the blank OB comprises a selector 90, i.e., a device configured to route the analyzed blank OB towards one of three different transport paths based on the result of the analysis carried out with the method 100 of the invention.

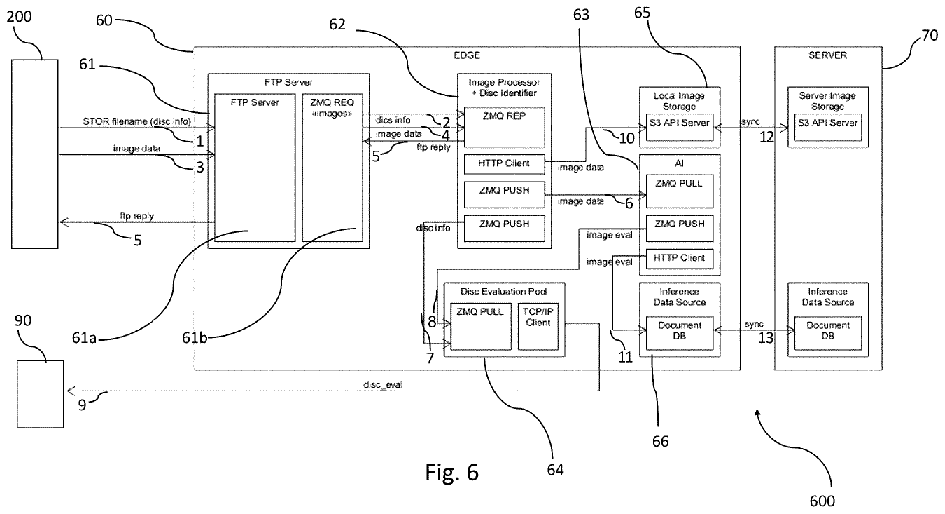

In particular, the result of the comparing step 105 is performed by electronic processing means 600 which will be described below in relation to FIG. 6, such processing means are configured to generate a respective selection signal 9 which arrives at the selector 90 to convey the blank OB on one of the three transport paths mentioned above.

The images acquired by the station 200 represent the input for the ML model capable of identifying the possible presence of defects thereon. In the case of the present invention, the transfer learning method was used to build the ML algorithm, i.e., a pre-trained algorithm on another dataset was chosen. Among those available, the Mask-RCNN model was chosen, based on neural networks (NN), trained on the COCO open source dataset.

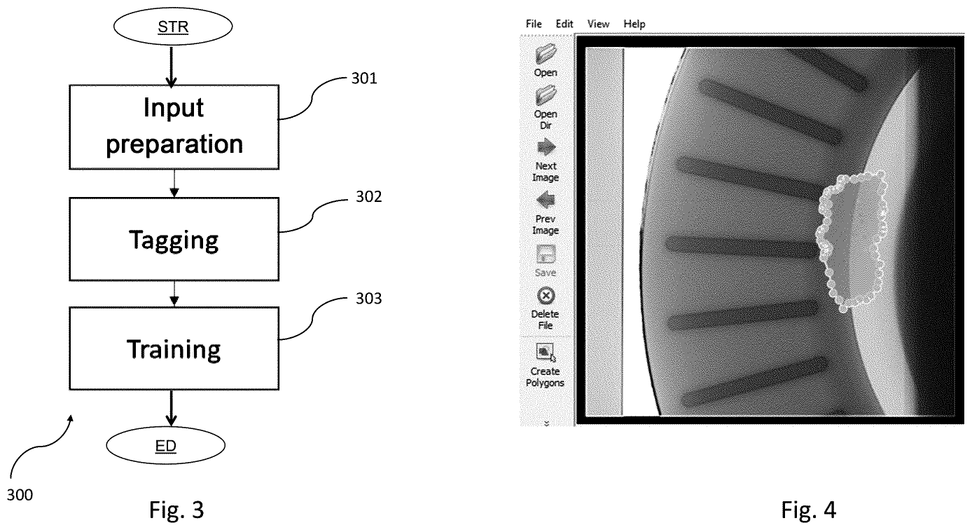

With reference to the embodiment in FIG. 3, the aforesaid trained algorithm of the method 100 is an algorithm trained by means of a preliminary training step 300, based on a training dataset comprising digital X-ray training images, which are provided as input 301 to the algorithm to be trained, depicting objects of the same type as the objects OB on which the defects should be identified and characterized. Such objects have defects with known type, respective dimensional parameter and respective positional parameter, which are also provided as input to the algorithm to be trained.

According to an implementation of the aforesaid embodiment, the preliminary training step 300 comprises a step of tagging or labeling 302 the known defects present in each of the digital training images.

A step of calibrating 303 the parameters of the algorithm to be trained based on the digital training images processed by tagging or labeling is then included.

According to possible implementations, the aforesaid tagging or labeling step 302 is carried out by highlighting the evident defects, on the radiographic training image, manually and/or with the support of facilitating software.

In accordance with a particular implementation example, the aforesaid tagging or labeling step is carried out by drawing a polygon on the digital training image, which traces the spatial trend of each defect, for example an evident crack or fissure, manually and/or with the support of facilitating software.

According to an implementation, the “labelMe” tool is used. Such a tool generates an “accompanying” file, the information content of which specifies where the cracks are located in the radiographic image, for example by reporting a list of coordinates in pixels for all the end points of the cracks present in the image. An example of a radiographic image of a brake disc labeled with the “labelMe” tool is shown in FIG. 4.

According to an embodiment of the method 100, the aforesaid trained algorithm is a machine learning algorithm based on neural networks.

According to various implementations, the aforesaid neural networks comprise deep neural networks, or convolutional neural networks or Region Based Convolutional Neural Networks.

According to another implementation, the aforesaid trained algorithm is a machine learning algorithm based on deep object detectors or two-stage deep object detectors.

In accordance with an embodiment of the method, the aforesaid step of identifying one or more defects within the object, present in the at least one acquired X-ray digital image, comprises the step of recognizing the defects, by the trained algorithm, and, for each recognized defect, identifying the spatial coordinates of the defect with respect to a reference coordinate system of the acquired digital image, to which the portions of the object depicted are also referred in a known manner.

Moreover, the aforesaid step of generating information related to each defect comprises generating, for each identified defect, digital information representative of the aforesaid spatial coordinates of the defect, and storing such digital information making it available for subsequent processing operations.

According to a particular embodiment, the aforesaid step of generating digital information comprises the step of determining, for each defect, the respective dimensional parameter and positional parameter based on the spatial coordinates of the defect.

In accordance with an embodiment, the method comprises, before the step of acquiring, the further steps of performing a calibration of the image acquisition means, and then acquiring data, following the calibration, to compensate for geometric distortion effects in the image acquisition.

In accordance with other implementations, the method is applied to identify and characterize defects present within objects in glassy, ceramic, cement, metallic materials.

Note that the method 100 shown above, due the features thereof, can be applied to a wide plurality of objects, also consisting of different materials than those mentioned above.

In a preferred embodiment, the method, performed according to any one of the embodiments shown above, is used in the field of detecting and monitoring cracks within a brake disc or a brake caliper.

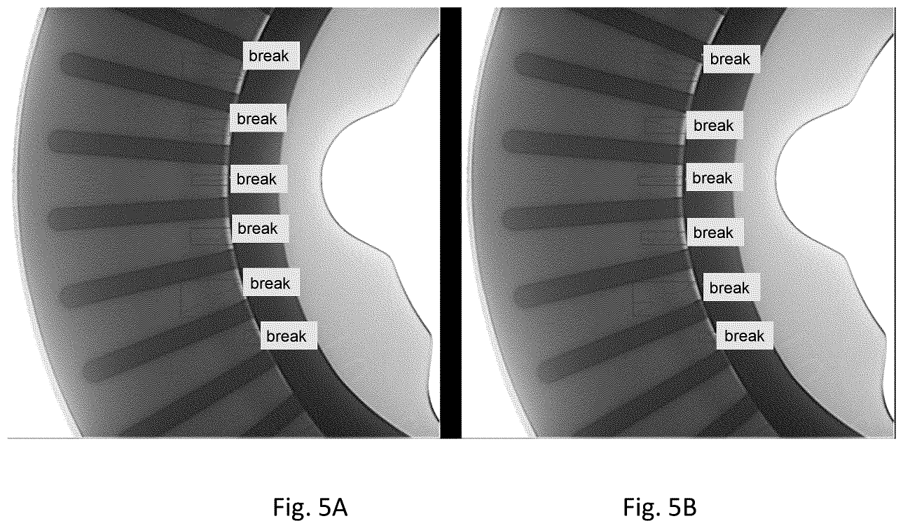

In a particular embodiment, the provision of all the information extracted for each foundry blank OB examined by means of a graphic interface to an operator is included, as shown in the radiographic image in FIG. 5B.

Moreover, displaying the data relating to the defects identified in a graphical form on the starting radiographic image, i.e., the image provided as input to the machine learning algorithm, during a training step, is included, as shown in FIG. 5A.

By means of such a graphical interface, it is also possible to access an archive of data relating to the blanks or discs previously x-rayed and analyzed.

Moreover, the method of the invention can be modified so as to make the check semi-automatic. In other words, under certain conditions, the operator is called to verify the output of the algorithm and to confirm or modify the decision taken by the modules implementing steps 105 and 106 of the method 100. Such predetermined conditions can concern, for example, the identification of a specific type of defect.

From a performance point of view, the Applicant has verified that the trained algorithm used by the method 100 is capable of obtaining “precision and recall” values both above 75% for all defect classes taken into consideration. Such a result is obtained by means of tests performed on appropriately constructed datasets so as to validate the algorithm.

An embodiment of a system 600 adapted to carry out the method 100 of the present invention, in particular the components of the system and the connections thereof are described below with reference to FIG. 6.

Such a system 600 comprises a first 60 and a second 70 computational unit.

The first computational unit (Edge) 60 is, for example, proximal to the station 200 for acquiring digital X-ray images along the production line in FIG. 2. Such a first computational unit 60 comprises a central processing unit or CPU and a hardware accelerator, in particular a graphics processing unit or GPU, configured to execute deep learning algorithms. Such a graphics processing unit is configured to execute software modules of the method 100 for identifying and characterizing defects present within the examined objects, substantially in near-real time.

The second computational unit 70 takes the form of a server unit. In an embodiment, such a server unit 70 is configured to be proximal to the digital X-ray image acquisition station 200 and connected to a single first computational unit 60 or to a plurality of such first computational units similar to one another.

In particular, such a server 70 is configured to store both the data on the analyzed digital X-ray images, as well as the results of the processing operations carried out by the first computational unit 60. Moreover, the server 70 operates to make such data and results usable by other services not falling within the object of the invention.

In greater detail, the first computational unit 60 is configured to execute a plurality of software modules as described below.

A first software module 61 comprises a server enabled for a subset of the FTP protocol, FTP Server 61a, for receiving images 3 and metadata 1 relating to an analyzed blank OB, for example a brake disc, and to the image, and made available from the digital X-ray image acquisition station 200 in a passive manner, for example by means of the name of the loaded image file.

Note that the use of the FTP protocol was adopted as a protocol compromising between the need to facilitate the implementation of a client outside the created software system and that of ensuring efficiency in the transfer of large files.

Such a first software module 61 is configured to avoid saving and permanently storing the received image files on a memory disk (hard disk). Instead, by keeping the data in a temporary memory, for example RAM, such a first software module 61 is configured to transfer, by means of the REQ-REP protocol implemented on a ZMQ socket 61b, the images 4 and the metadata 2 relating to the brake disc to a second software module 62 dedicated to the pre-processing, validation and identification of the single image file.

Such a second software module 62 (Image Processor +Disc Identifier) is dedicated to the pre-processing, validation and identification of the single image file, after having compared metadata with the content of the image file and having verified the consistency thereof with respect to previous information received. The second software module 62 is configured to provide the ftp server 61a with a response code 5 (ftp reply) which, in turn, the first software module 61 is adapted to return to the digital X-ray image acquisition station 200. Note that the FTP protocol provides that, following a request or the completion of an operation by a client, the server returns a response code indicating the success or the type of failure encountered. In the case in hand, checks which are not typical of standard FTP servers are carried out (for example, if the name of the file is as agreed and the information contained therein makes sense) which are delegated to the second software module 62. Therefore, before responding to the client with the code, the FTP server awaits, in turn, the result of the check performed by the second software module 62.

The second software module 62 is configured to decode the image by preparing an array directly usable by a neural network (AI) implemented within a third software module 63.

Moreover, the second software module 62 is configured to send, by means of the PUSH-PULL protocol implemented on ZMQ sockets, metadata 7 relating to the brake disc currently under examination to a fourth software module 64 for the possible recording of a new disc under evaluation.

Again, by means of the PUSH-PULL protocol implemented on a ZMQ socket, the second software module 62 is also configured to send the image data 6 to the third software module 63 for the identification and localization of defects.

By means of a separate path with respect to that of disposal of the queue generated by the execution of the REQ-REP protocol, the second software module 62 is also configured to send the received image data 10 towards a fifth software module 65 by means of the HTTP protocol.

In greater detail, the above-mentioned fourth software module 64, Disc Evaluation Pool, is dedicated to aggregating the result of several deductions or inferences performed on the totality of acquired images for one or more brake discs under evaluation, and to communicating the result of such an evaluation for a disc by sending a signal 9 (disc_eval) to the selector 90 described with reference to FIG. 2 (good disc, reject disc, disc to be reworked) by means of a communication over the TCP/IP protocol.

Moreover, such a fourth software module 64 is configured to record the presence of a new disc under examination following the reception of the data 7 from the second software module 62, and to update the aggregate result at each reception of data relating to the evaluation of the image 8 received by the third software module 63.

As mentioned above, the third software module 63 is configured to identify and locate defects within X-ray images of a brake disc. The hardware accelerator associated with the first computational unit 60 is used to execute the inference. The images are received 6 by means of the PUSH-PULL protocol on zmq sockets and in the same manner the results of the inferences are sent to the fourth software module 64.

Since the third software module 63 is kept separate from the others and it is powered with an independent queue, the use of the hardware resources by this third software module (specifically the GPU graphics accelerator) occurs in conjunction with the use of the hardware resources by the other software modules, specifically the CPU by the second software module 62. Thereby, situations are avoided in which one of the hardware resources is waiting for another hardware resource to complete an activity before being able to perform an assigned task. In other words, the graphics accelerator always works in parallel with the CPU.

Moreover, the use of protocols designed for high performance (such as all protocols on ZMQ sockets) when transferring the image data received from the first software module 61 to the third software module 63 allows minimizing the latency introduced by overheads, which are conventionally necessary to keep different services separate from each other, in particular when powered by mechanisms involving queue management. For example, it is possible to avoid making an in-memory copy of the image data at each image transfer from one module to the next one.

In a separate path with respect to that of disposal of the queue generated by the execution of the PUSH-PULL protocol for receiving the images, the third software module 63 is adapted to transfer the result of the executed inferences 11 towards a sixth software module 66 by means of the HTTP protocol.

For example, the fifth software module 65 mentioned above is a local server, Local Image Storage, dedicated to maintaining the image data for a limited period of time, S3 API Server, and to transferring it to the server unit 70.

For example, the sixth software module 66, Inference Data Source, is a document database, Document DB, dedicated to maintaining the results of inferences for a limited period of time and for transferring them to the server unit 70.

In an alternative embodiment, such a system 600 comprises only the first computational unit 60 configured to be connected to a respective remote server by means of the Internet (in the Cloud). Such a remote server is configured to perform, from a functional point of view, the same functions as the server unit 70 described above.

In another alternative embodiment, such a system 600 is configured to use protocols on zmq sockets only for the transfer of the image data and to use appropriate REST servers to manage all other communications.

In order to meet contingent needs, those skilled in the art may make changes and adaptations to the embodiments of the method described above or can replace elements with others which are functionally equivalent, without departing from the scope of the following claims. Each of the features described above as belonging to a possible embodiment can be implemented irrespective of the other embodiments described.

1-16. (canceled)

17. A method (100) for identifying and characterizing defects within an object (OB), comprising the steps of:
acquiring (101) at least one digital X-ray image of the object (OB) or of a part of the object within which the defects are to be identified;
providing (102) said at least one acquired digital image to a trained artificial intelligence, AI, and/or machine learning, ML, algorithm;
analyzing (103), by said trained algorithm, said at least one acquired digital image to identify one or more defects present in the at least one acquired digital image;
generating (104) digital information on each identified defect, comprising a step of determining (104′) one or more parameters representative of said defect to characterize the defect;
comparing (105) each of said one or more parameters representative of the identified defect with respective one or more reference values;
providing (106) a piece of information (IQ1, IQ2, IQ3) representative of the quality of the object (OB) based on said comparison, said comparing step (105) being performed through a further processing of said digital information, by electronic processing means.

18. A method (100) for identifying and characterizing defects according to claim 17, wherein said step of determining (104′) one or more parameters representative of the identified defect comprises a step of determining:
a type of defect;
at least one dimensional parameter of the defect, representative of at least one dimension of the defect within the object (OB);
at least one positional parameter of the defect, representative of a position of the defect within the object (OB) with respect to a reference point or line present in the digital X-ray image or to a two-dimensional spatial coordinate system associated with said reference point or line.

19. A method (100) for identifying and characterizing defects according to claim 17, wherein said step of providing (106) a piece of information (IQ1, IQ2, IQ3) representative of the quality of the object (OB) comprises a step of providing:
a first quality information (IQ1) characterizing the object (OB) as suitable when at least one of said one or more parameters representative of the identified defect takes a value less than or equal to the respective reference value; or
a second quality information (IQ2) characterizing the object (OB) as a reject when each of said one or more parameters representative of the identified defect takes a value greater than the respective reference value; or
a third quality information (IQ3) characterizing the object (OB) as an object to be reworked when each of said one or more parameters representative of the identified defect takes a value greater than the respective reference value, and at least one of said one or more parameters representative of the defect can be modified by reworking to take a value less than or equal to the respective reference value.

20. A method (100) for identifying and characterizing defects according to claim 19, wherein said parameter representative of the defect of the object (OB), being modifiable by reworking, is the type of the defect and, after the step of providing the third quality information (IQ3) the method comprises a step of reworking (106′) the object (OB) to generate a reworked object (OB'),
acquiring (101) at least one digital X-ray image of the reworked object (OB') to be provided to a trained artificial intelligence, Al, and/or machine learning, ML, algorithm to repeat said method (100) so as to identify and characterize defects within said reworked object (OB').

21. A method (100) for identifying and characterizing defects according to claim 17, wherein the method is configured to identify and characterize defects within the body of an object (OB) placed on a working surface (PL) along a working line (50) using a station (200) for acquiring digital X-ray images operatively associated with the working surface (PL); and wherein:
said acquiring step (101) comprises a step of sequentially acquiring a plurality (N) of digital X-ray images of the object (OB), each of said digital images being acquired by modifying a first rotation angle (a1) of a source (20) of X-ray beams (21) of the image acquisition station (200) incident on said object (OB) with respect to an axis (24) parallel to the working surface (PL), or by modifying a second rotation angle (a2) of a source (20) of X-ray beams (21) of the image acquisition station (200) incident on said object (OB) with respect to the working surface (PL);
continuously performing, in sequence, the steps of providing and analyzing each digital image of said plurality (N) of acquired images;
for each digital image of said plurality (N) of acquired images, continuously performing, in sequence, the step of generating (104) digital information on each identified defect, said step comprising the steps of:
determining (104′) one or more parameters representative of said defect to characterize the defect,
updating (104″) said one or more parameters representative of said defect so as to monitor the three-dimensional characterization of the defect regarding the type of the defect, the dimension of the defect, and the position of the defect in the image.

22. A method (100) for identifying and characterizing defects according to claim 21, wherein said digital X-ray image acquisition station (200) operatively associated with the working surface (PL) comprises a digital X-ray image acquisition unit (22) connected to the source of X-ray beams (21) and to a screen (23) for detecting digital radiographic images, said screen (23) being movable, by the digital image acquisition unit (22), in an integral manner with the source (20) to rotate about said axis (24) parallel to the working surface (PL) so that the first rotation angle (a1) of the source (20) of X-ray beams (21) with respect to said axis (24) takes values from 0° to 360°,
said step of sequentially acquiring (101) a plurality (N) of digital X-ray images of the object (OB) comprises a step of acquiring each image of the plurality at a respective plurality of values of the first rotation angle of the source (20) with respect to the axis (24).

23. A method (100) for identifying and characterizing defects according to claim 21, wherein said digital X-ray image acquisition station (200) operatively associated with the working surface (PL) comprises a digital X-ray image acquisition unit (22) connected to the source of X-ray beams (21) and to a screen (23) for detecting digital radiographic images, said screen (23) being movable, by the digital image acquisition unit (22), in an integral manner with the source (20) to rotate about the working surface (PL) so that the second rotation angle (a2) of the source (20) of X-ray beams (21) with respect to said surface takes values from 0° to 360°,
said step of sequentially acquiring (101) a plurality (N) of digital X-ray images of the object (OB) comprises a step of acquiring each image of the plurality at a respective plurality of values of the second rotation angle of the source (20) with respect to the working surface (PL).

24. A method (100) for identifying and characterizing defects according to claim 17, wherein said trained algorithm is an algorithm trained by means of a preliminary training step (300), said preliminary training step comprising a step of providing as input (301) to the algorithm to be trained a training dataset comprising digital X-ray training images depicting objects (OB) of the same type as the objects within which the defects are required to be identified and characterized, said objects having defects with known type, respective dimensional parameter, and respective positional parameter, which are also provided as input to the algorithm to be trained.

25. A method (100) for identifying and characterizing defects according to claim 24, wherein said preliminary training step (300) further comprises the steps of:
performing a tagging (302) or labeling of the known defects present in each of the digital X-ray training images;
calibrating (303) the parameters of the algorithm to be trained based on the digital training images processed by tagging or labeling.

26. A method (100) for identifying and characterizing defects according to claim 25, wherein said tagging or labeling step (302) is performed by highlighting the apparent defects within the body of the object (1), on the digital training image, manually and/or with the aid of facilitating software.

27. A method (100) for identifying and characterizing defects according to claim 24, wherein said trained algorithm is a machine learning, ML, algorithm, based on neural networks.

28. A method (100) for identifying and characterizing defects according to claim 27, wherein said neural networks comprise deep neural networks or region-based convolutional neural networks.

29. A method (100) for identifying and characterizing defects according to claim 24, wherein said trained algorithm is a machine learning algorithm based on deep object detectors or two-stage deep object detectors.

30. A method (100) for identifying and characterizing defects according to claim 17, wherein the aforesaid step of identifying one or more defects within the object (OB), present in the at least one acquired digital X-ray image, comprises the step of recognizing the defects, by the trained algorithm, and for each recognized defect, identifying the spatial coordinates of the defect with respect to a reference coordinate system of the acquired digital image, to which the portions of the object depicted are also referred in a known manner.

31. A method (100) for identifying and characterizing defects according to claim 30, wherein the aforesaid step of generating information on each defect comprises generating, for each recognized defect, digital information representative of the aforesaid spatial coordinates of the defect, and storing such digital information making it available for subsequent processing operations.

32. A method (100) for identifying and characterizing defects according to claim 31, wherein the aforesaid step of generating digital information comprises the step of determining, for each defect, the respective dimensional parameter and positional parameter based on the spatial coordinates of the defect.
